(19) United States
(12) Patent Application Publication
(10) Pub. No.: US 2012/0105243 A1
(43) Pub. Date: May 3, 2012

(54) RADIO ACTIVATED DANGER WARNING SYSTEM

(75) Inventor: Raymond Francis Datodi, Yallingup (AU)

(73) Assignee: RABWA PTY LTD., Willetton, Western Australia (AU)

(21) Appl. No.: 13/381,819

(22) PCT Filed: Jul. 5, 2010
(86) PCT No.: PCT/AU10/00860

§ 371 Date: Dec. 30, 2011

(30) Foreign Application Priority Data
Jul. 3, 2009 (AU) 2009903122
Nov. 26, 2009 (AU) 2009905789

(51) Int. Cl. G08B 21/00

(52) U.S. Cl. 340/686.6

(57) ABSTRACT

A radio activated danger warning system in the form of a radio activated bush fire warning system 10 comprising transmitting means 12 for transmitting a coded signal to a plurality of geographical zones 14, each zone 14 having a unique code assigned to it. The radio activated bush fire warning system 10 further comprises a plurality of receiving means 22 in the geographical zones 14 for receiving the coded signal and generating an alarm to warn of the approach of a fire. Each of the receiving means 22 advantageously includes a GPS receiver and a comparing means whereby, in use, it can obtain its current GPS coordinates and compare them with the GPS coordinates of the danger zone. In use, only those receiving means 22 located in the danger zone and receiving coded signals with the unique code assigned to that zone will generate an alarm.

### FIELD OF THE INVENTION

The present invention relates to a radio activated system and method for providing early warning of a danger, and relates particularly, though not exclusively, to such a system that employs digitally encoded radio transmission. The system has particular application to a warning system for bush fires.

### BACKGROUND TO THE INVENTION

The recent disastrous bush fires in Victoria have again highlighted the need to provide an effective early warning bush fire alert system. The approaching fire fronts in the Victorian bush fires were moving so rapidly that conventional warning systems were ineffective in providing residents in the danger zones with sufficient warning. Current methods available to fire authorities and other persons responsible to warn residents of approaching fires rely on land line telephones, mobile telephones and SMS, local radio station broadcasts and personal contact by physically travelling to the locations at risk and warning people directly of the impending danger.

There are problems and disadvantages with each of the above current modes of communication. Many residences use cordless telephones and on the highly likely event of a power failure, linked to the approaching fire, their telephone is rendered inoperative. There is also the danger of telephone land lines being cut during a fire so that land line communications are lost. Mobile phones may be switched off or in a no-signal area, which is common in remote areas where signal strength can fluctuate significantly depending on location. Even where a signal is present, SMS is a low priority transmission and latency of signal transmission can vary from minutes to hours. Very few people are always tuned-in or listening to the local radio station from where fire warnings may be transmitted. It is practically impossible to physically locate and contact every person in a danger zone to warn them directly.

The present invention was developed with a view to providing a radio activated danger warning system and method, such as for bush fires, which is less susceptible to at least some of the problems of the above prior art systems and methods.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a radio activated danger warning system comprising:

transmitting means for transmitting a coded signal to a plurality of geographical zones, each zone having a unique code assigned to it; and,
a plurality of receiving means in the geographical zones for receiving the coded signal and generating an alarm to warn of the approach of a danger wherein, in use, only those receiving means belonging to a zone where there is an impending danger hazard and receiving coded signals with the unique code assigned to that zone will generate an alarm.

Preferably the coded signal is a digitally encoded signal. Preferably the unique code includes global positioning coordinates defining a danger zone in which there is the impending danger. Preferably the global positioning coordinates define a geofence. Advantageously the size and location of the geofence can vary dynamically as the danger zone varies with the movement of the danger.

Preferably each receiving means comprises a radio receiver and a decoding means. Preferably each receiving means also comprises an alarm means for generating an audible alarm. If desired the alarm means may also generate a visual alarm and/or a vibration alarm if it is, for example, a portable receiving means.

Typically the danger is a bush fire, tsunami, earthquake, flood, storm or terrorist attack.

According to another aspect of the present invention there is provided a radio activated danger warning method comprising the steps of:

transmitting a coded signal to a plurality of geographical zones, each zone having a unique code assigned to it;
receiving the coded signal in all the geographical zones; and,
generating an alarm to warn of the approach of a danger wherein, in use, only those coded signals having the unique code assigned to a zone where there is an impending danger hazard will result in the generation of an alarm.

Preferably the coded signal is a digitally encoded signal. Preferably the unique code includes global positioning coordinates defining a danger zone in which there is the impending danger hazard. Preferably the global positioning coordinates define a geofence. Advantageously the size and location of the geofence can vary dynamically as the danger zone varies with the movement of the hazard.

The coded signal may, in addition to the unique code for the specific geographical zone in which there is an impending danger, include alert codes indicating the level of danger. Typically it may include a moderate danger alert, an urgent danger alert, and an immediate danger alert, depending on the speed and ferocity of the approaching danger front. The method preferably further includes the steps of decoding the coded signal, identifying the zone and the level of danger, before the step of generating the appropriate alarm.

According to a still further aspect of the present invention there is provided a receiving means for a radio activated danger warning system in which a coded signal is transmitted to a plurality of geographical zones, each zone having a unique code assigned to it, the receiving means comprising:

decoding means for decoding the coded signal and alarm means for generating an alarm to warn of the approach of a danger wherein, in use, only if the receiving means belongs to a zone where there is an impending danger hazard and receives a coded signal with the unique code assigned to that zone will it generate an alarm.

Preferably the receiving means further comprises a radio receiver for receiving the coded signal and providing the signal to the decoding means. Preferably the receiving means includes a GPS receiver and a comparing means whereby, in use, it can obtain its current GPS coordinates and compare them with the GPS coordinates of the danger zone. Preferably the alarm means generates an audible alarm. If desired the alarm means may also generate a visual alarm and/or a vibration alarm if it is, for example, a portable receiving means.

According to yet another aspect of the invention there is provided a radio activated danger warning system comprising:

transmitting means for transmitting a coded signal to a geographical area, the coded signal including global positioning coordinates defining a danger zone in which there is an impending danger hazard within the geographical area; and,
a plurality of receiving means in the geographical area for receiving the coded signal and generating an alarm to warn of the approach of a danger wherein, in use, only those receiving means located within the danger zone and receiving the coded signal will generate an alarm.

Typically the danger zone is defined by a geofence. Advantageously the size and position of the geofence can vary dynamically as the danger zone varies with the movement of the danger. Preferably the global positioning coordinates for the geofence are derived from the Global Positioning System (GPS). However it will be understood that the global positioning coordinates may be derived from any suitable Global Navigation Satellite System (GNSS).

Preferably each receiving means includes a GPS receiver and a comparing means whereby, in use, it can obtain its current GPS coordinates and compare them with the geofence.

According to still another aspect of the present invention there is provided a radio activated danger warning method comprising the steps of:

transmitting a coded signal to a geographical area, the coded signal including global positioning coordinates defining a danger zone in which there is an impending danger hazard within the geographical area;
receiving the coded signal in the geographical area;
comparing the global positioning coordinates at the point of reception with the global positioning coordinates defining the danger zone; and,
generating an alarm to warn of the approach of a danger wherein, in use, only those coded signals received within the danger zone will result in the generation of an alarm.

Preferably the global positioning coordinates define a geofence. Advantageously the size and location of the geofence can vary dynamically as the danger zone varies with the movement of the danger.

According to a yet further aspect of the present invention there is provided a receiving means for a radio activated danger warning system in which a coded signal is transmitted to a geographical area, the coded signal including global positioning coordinates defining a danger zone in which there is an impending danger hazard within the geographical area, the receiving means comprising:

decoding means for decoding the coded signal and alarm means for generating an alarm to warn of the approach of a danger wherein, in use, only if the receiving means is located within the danger zone and receives the coded signal will it generate an alarm.

Preferably the receiving means further comprises a radio receiver for receiving the coded signal and providing the signal to the decoding means. Preferably the global positioning coordinates define a geofence. Advantageously the size and location of the geofence can vary dynamically as the danger zone varies with the movement of the danger. Advantageously the global positioning coordinates for the geofence are derived from the Global Positioning System (GPS). Preferably the receiver further comprises a GPS receiver and a comparing means whereby, in use, it can obtain its current GPS coordinates and compare them with the geofence. Preferably the decoding means includes a GPS decoder.

According to another aspect of the present invention there is provided a radio activated bush fire warning system comprising:

transmitting means for transmitting a coded signal to a plurality of geographical zones, each zone having a unique code assigned to it; and,
a plurality of receiving means in the geographical zones for receiving the coded signal and generating an alarm to warn of the approach of a fire wherein, in use, only those receiving means belonging to a zone where there is an impending fire hazard and receiving coded signals with the unique code assigned to that zone will generate an alarm.

Preferably the coded signal is a digitally encoded signal. Preferably the unique code includes global positioning coordinates defining a danger zone in which there is an impending fire hazard. Preferably the global positioning coordinates define a geofence. Advantageously the size and location of the geofence can vary dynamically as the danger zone varies with the movement of the fire.

Preferably each receiving means comprises a radio receiver and a decoding means. Preferably each receiving means also comprises an alarm means for generating an audible alarm. If desired the alarm means may also generate a visual alarm and/or a vibration alarm if it is, for example, a portable receiving means.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of a radio activated danger warning system and method, in the form of a radio activated bush fire warning system and method, given by way of example only, with reference to the accompanying drawings, in which:

FIG. 1 is a schematic diagram illustrating a first embodiment of a radio activated bush fire warning system and method according to the invention;

FIG. 2 is a block diagram illustrating a first embodiment of a receiving means employed in the system of FIG. 1;

FIG. 3 is a diagram for illustrating a second embodiment of a radio activated bush fire warning system and method according to the invention; and,

FIG. 4 is a block diagram illustrating a second embodiment of a receiving means employed in the system of FIG. 3.

### DETAILED DESCRIPTION OF PREFERRED EMBODIMENTS

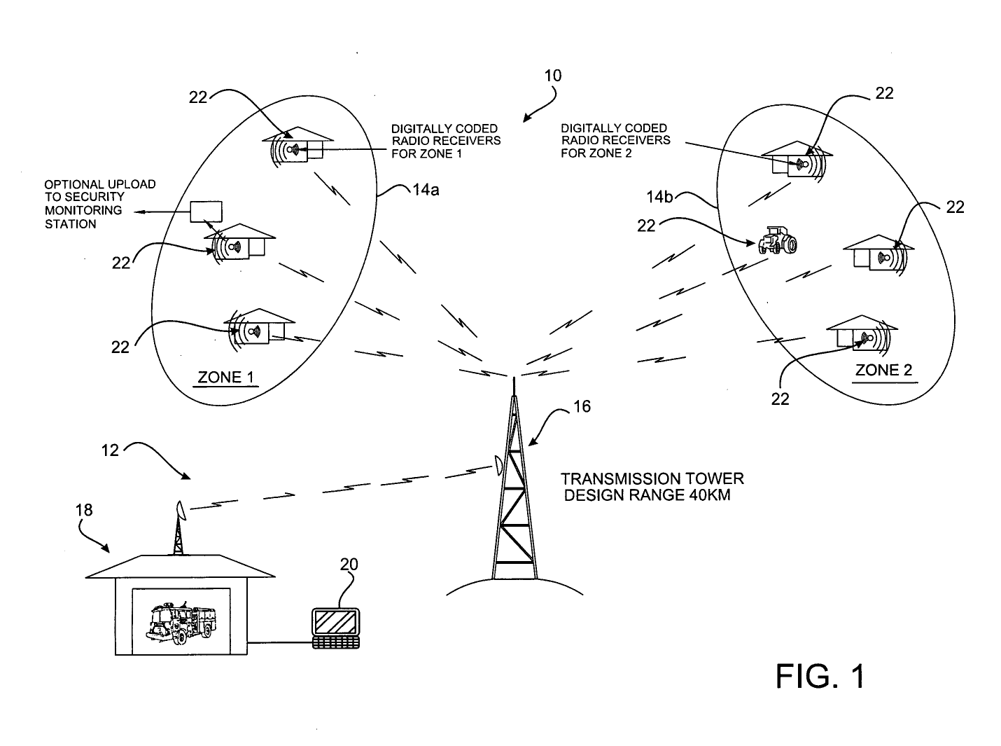

A first embodiment of the radio activated bush fire warning system 10, as shown in FIG. 1, comprises a transmitting means 12 for transmitting a coded radio signal to a plurality of geographical zones 14a, 14b, etc, each zone having a unique code assigned to it. Preferably the radio signal is digitally encoded to warn residents in the plurality of zones in a remote geographical area of impending bush fire danger. The use of digitally encoded radio transmission permits discrete zones within the full range of the transmitted signal to be warned of an impending fire hazard in that specific area or zone.

As shown in FIG. 1, the transmitting means 12 of this embodiment comprises a radio transmission tower 16 with a typical transmission range of about 40 km radius. The digitally encoded signal is transmitted to the transmission tower 16 via a satellite, microwave or VHF link from the local fire authority control centre 18. The control centre 18 is equipped with a computer controlled early-warning system 20, which includes a database of all the geographical zones 14 within the transmission range of the tower 16, and the unique codes assigned to each zone 14 respectively.

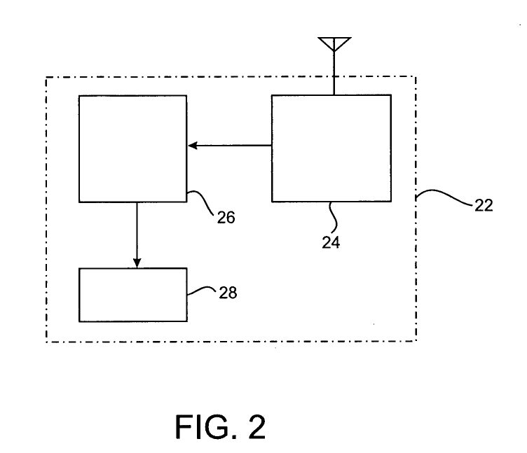

The bush fire warning system 10 further comprises a plurality of receiving means 22 in each of the geographical zones 14 for receiving the coded signal and generating an alarm to warn of the approach of a fire. Preferably each receiving means 22 comprises a radio receiver 24 and a decoding means 26, as shown in FIG. 2. In use, only those receiving means 22 belonging to a geographical zone 14 and receiving coded signals with the unique code assigned to that zone will generate an alarm. Preferably each receiving means 22 also comprises an alarm means 28 for generating an audible alarm. If desired the alarm means 28 may also generate a visual alarm and/or a vibration alarm if it is, for example, a portable, pocket-held or hand-held receiving means 22.

The decoding means 26 typically comprises a digital decoder for decoding the digitally encoded signal transmitted from the control centre 18 via the transmission tower 16. The digitally encoded signal may, in addition to the unique code(s) for the specific geographical zone(s) 14 in which there is an impending fire danger, include codes indicating the level of danger. For example, it may include a moderate danger alert, coded “BLUE”, an urgent danger alert, coded “ORANGE”, and an immediate danger alert, coded “RED”, depending on the speed and ferocity of the approaching fire front. The digital decoder 26 decodes the digitally encoded signal and identifies the zone and the level of danger, and then sends an activation signal to the alarm means 28 to generate the appropriate alarm.

Each receiving means 22 is preferably of a relatively small size and either battery-operated or mains-powered with battery back-up. Multiple units may be utilized at each residential site, including portable units capable of being carried at all times by persons, for example farmers, working in locations on the property remote from the dwelling. Each unit 22 in a particular zone 14 is coded with the unique code assigned to that zone. Advantageously the database of the computer controlled early-warning system 20 also includes a record of each registered receiving means 22 in all of the zones 14.

Optional additional features of the receiving means 22 include an interface for electronically interfacing the decoding means 26 with an existing residential monitored burglar alarm system and/or automatic sprinkler system. In the event of an impending fire danger, the decoding means sends an alarm signal to the burglar alarm system which in turn transmits a warning signal to the monitoring service. In the event that the owner/occupant is away from their residence the monitoring service can contact the owner/occupant and alert them to the impending fire danger. Depending on the level of danger, the receiving means 22 can also be programmed to activate an automatic sprinkler system to help protect the house from fire.

A preferred sequence of steps employed in the radio activated bush fire warning method according to the invention will now be described with reference to FIG. 1. Each zone 14 in the region under the control of the control centre 18 has previously been allocated a unique code which is stored in the database held in the computer system 20 at the control centre 18. In the event of a fire in, or in the vicinity of, a particular zone 14, a computer generated command would be activated by a person in charge of the control centre 18. A digitally encoded signal which includes the unique code assigned to that zone is then transmitted to the transmission tower 16 via the satellite, microwave or VHF link, and from there it is broadcast over the entire area to all of the geographical zones 14 within the transmission range of the tower.

The coded signal is received by all the receiving means 22 in all of the geographical zones 14. However only the receiving means 14 coded with the unique code assigned to the zone where there is an impending fire danger will be able to decode the signal and generate an alarm to warn of the approach of a fire. Therefore only those coded signals having the unique code assigned to that zone will result in the generation of an alarm, whether the receiving means 22 is in or out of that specific zone. Persons carrying portable receiving means 22 would therefore be notified of the fire hazard in their own zone and preferably also of the level of danger, and would then be in a better position to decide how best to manage the evacuation or rescue of family members and/or animals on their property at the time of the warning.

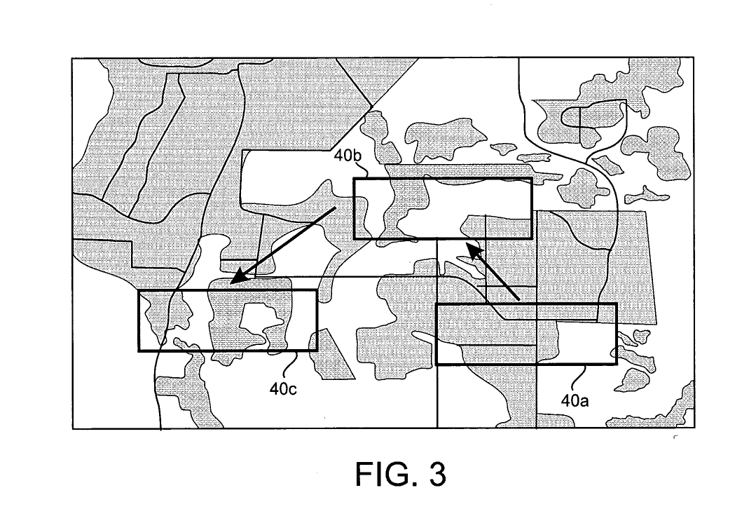

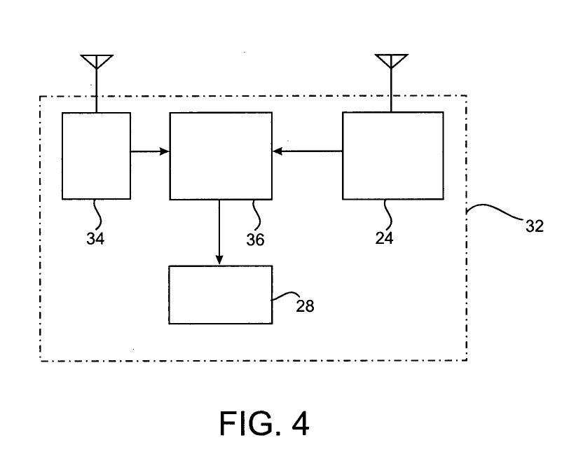

FIGS. 3 and 4 illustrate a second embodiment of a radio activated bush fire warning system 30 according to the present invention. The system 30 is similar to the first embodiment 10, and therefore the similar components of the system 30 will be designated with the same reference numerals as the like components in the system 10. The principal difference of the system 30 is its ability to activate alarms based on GPS coordinates compared with the previously described discrete zones to which digitally coded alarms are allocated in a data base.

The radio activated bush fire warning system 30 is similar to that illustrated in FIG. 1 and comprises a transmitting means 12 for transmitting a coded radio signal to one or more geographical zones 40a, 40b, etc within a remote geographical area (see FIG. 3). Preferably the radio signal is digitally encoded to warn residents in the plurality of zones in a remote geographical area of impending bush fire danger. The use of digitally encoded radio transmission permits discrete zones within the full range of the transmitted signal to be warned of an impending fire hazard in that specific area or zone. Advantageously the coded radio signal includes global positioning coordinates defining a danger zone 40 in which there is an impending fire hazard within the geographical area. Preferably the danger zone 40 is defined by a “geofence”. A “geofence” is a virtual boundary or border established in a host database or computer facility, based on the global positioning coordinates of a danger zone supplied to the host computer. Advantageously the size and location of the geofence can vary dynamically as the danger zone varies with the movement of the fire. Preferably the global positioning coordinates for the geofence are derived from the Global Positioning System (GPS). However it will be understood that the global positioning coordinates may be derived from any suitable Global Navigation Satellite System (GNSS). Global Navigation Satellite System (GNSS) is the standard generic term for satellite navigation systems that provide autonomous geo-spatial positioning with global coverage.

As with the system 10 shown in FIG. 1, the transmitting means 12 of this embodiment comprises a radio transmission tower 16 with a typical transmission range of about 40 km radius. The digitally encoded signal is transmitted to the transmission tower 16 via a satellite, microwave or VHF link from the local fire authority control centre 18. The control centre 18 is equipped with a computer controlled early-warning system 20. The bush fire warning system 30 further comprises a plurality of receivers 32 spread throughout the remote geographical area for receiving the coded signal and generating an alarm to warn of the approach of a fire.

Preferably each receiver 32 of this embodiment comprises a radio receiver 24 and a microprocessor based decoding means 36, as shown in FIG. 4. Advantageously the receiver 32 further comprises a GPS module 34 that can “self-learn” by downloading the receiver's current global position and the receiver's microprocessor storing this information for future processing. Alternately, for receivers not utilising an inbuilt GPS option, the receiver's global position may be downloaded via an external GPS at the time of installing the device. Preferably each receiver 32 also comprises an alarm means 28 for generating an audible alarm. As with the previous embodiment, the alarm means 28 may also generate a visual alarm and/or a vibration alarm if it is, for example, a portable, pocket-held or hand-held receiving means 32.

The microprocessor based decoding means 36 typically comprises a digital decoder for decoding the digitally encoded signal transmitted from the control centre 18 via the transmission tower 16. At the control centre 18, the specific geographical area under threat may be defined by the computer controlled early-warning system 20 by inscribing a polygon (“geofence” 40) on a map of the general area depicted on a computer screen, as illustrated in FIG. 3. The boundaries of the geofence 40, as inscribed by the geometrical dimensions of a polygon, encompass the total longitudinal and latitudinal coordinate data of the geographical area under threat of an approaching bush fire.

The number, sizes and the geographic locations of the geofences 40 are dynamic, able to be sized and moved seamlessly around the map of the general area as displayed on the computer screen. The size and shape of the polygon(s) (geofence(s) 40) defining the area(s) under threat and their position(s) on the screen would be dependent upon the extent, direction and ferocity of the approaching fire front(s).

Once the size and the geographic location of the area under threat have been defined on the local map as displayed on the computer screen, a “Send Alarm” command would then be initiated by the computer controlled early-warning system 20. The transmitted, digitally coded radio signal, containing the GPS coordinates defining the geofence 40, is typically received by all receivers 32 within radio range of the transmitted signal. Each receiver 32 then decodes the received geofence coordinates and compares this data with its own stored GPS location. If the receiver's GPS coordinates fall inside the range of the transmitted GPS coordinates encompassed by the geofence (the polygon on the map), an alarm is activated. Thus all receivers 32 within the boundaries of a geofence 40 can be activated in accordance with the level of threat.

The digital decoder 36 decodes the digitally encoded signal and identifies the level of danger, and then sends an activation signal to the alarm means 28 to generate the appropriate alarm. i.e. BLUE, ORANGE or RED alert as embedded in the coded transmission. As the fire front approaches, the position and size of the danger zone, as defined by the geofence 40, may be altered dynamically, moved seamlessly around the map on the computer screen as required, and retransmitting the appropriate digitally encoded signal.

A significant advantage of the “self-learning” GPS option is the removal of the need to maintain a Zone Data Base where alarm coded addresses need to be allocated to specific zones for selective alarming of all radio activated alarms within the area of transmission. The logistics of entering thousands of alarms to specific zones and the ongoing maintenance of such a data base are eradicated by the GPS option described above.

An additional advantageous feature is the option of enabling the system to be controlled remotely over the internet. Since it is a digital system the process of defining areas under threat and sending the appropriate alarm can be managed remotely via internet transmission. This is an advantageous feature, since if the system is utilised as part of an overall emergency warning facility, centralised control will be an important requirement.

Now that preferred embodiments of the radio activated danger warning system and method, in the form of a radio activated bush fire warning system and method, have been described in detail, it will be apparent that the embodiments provide a number of advantages over the prior art, including the following:
(i) The system can ensure that residents in remote areas will receive warning of an impending danger such as a fire hazard, even in the event of a power failure.
(ii) The system is simple to install. High-powered digital radio transmitters may be mounted on existing radio towers wherever possible.
(iii) The use of digitally encoded transmission permits discrete zones within the range of the transmitted signal to be warned of an impending danger such as a fire hazard threatening that specific zone.
(iv) The “self learning” GPS option means that the system will operate wherever the receiver may be located within the geographical area covered by the system.
(v) The use of a geofence to define the danger zone(s) allows the size, location and number of danger zones to be varied dynamically depending on the level of threat from the danger such as fire front(s).

Whilst the description and embodiments relate to a radio activated bush fire warning system and method, it should be understood that the system and method would also be applicable to other natural disasters such as earthquakes, tsunamis, floods, storms and cyclones, as well as other dangers such as terrorist attacks.

It will be readily apparent to persons skilled in the relevant arts that various modifications and improvements may be made to the foregoing embodiments, in addition to those already described, without departing from the basic inventive concepts of the present invention. For example, the digital coded signal may also incorporate additional information, for example, a text message that may be received and read on a digital readout at the receiver. Whilst the polygon defining the illustrated geofence is a rectangle, it will be understood that the geofence may be defined using any shaped polygon. Therefore, it will be appreciated that the scope of the invention is not limited to the specific embodiments described.

1. A radio activated danger warning system comprising:
transmitting means for transmitting a coded signal to a plurality of geographical zones, each zone having a unique code assigned to it; and,
a plurality of receiving means in the geographical zones for receiving the coded signal and generating an alarm to warn of the approach of a danger wherein, in use, only those receiving means belonging to a zone where there is an impending danger hazard and receiving coded signals with the unique code assigned to that zone will generate an alarm.

2. A radio activated danger warning system as defined in claim 1, wherein the coded signal is a digitally encoded signal.

3. A radio activated danger warning system as defined in claim 1 or claim 2, wherein the unique code includes global positioning coordinates defining a danger zone in which there is the impending danger hazard.

4. A radio activated danger warning system as defined in claim 3, wherein the global positioning coordinates define a geofence.

5. A radio activated danger warning system as defined in claim 4, wherein the size and location of the geofence can vary dynamically as the danger zone varies with the movement of the danger.

6. A radio activated danger warning system as defined in any one of the preceding claims, wherein each receiving means comprises a radio receiver and a decoding means.

7. A radio activated danger warning system as defined in claim 6, wherein each receiving means also comprises an alarm means for generating an audible alarm.

8. A radio activated danger warning system as defined in claim 7, wherein the alarm means also generates a visual alarm and/or a vibration alarm.

9. A radio activated danger warning method comprising the steps of:
transmitting a coded signal to a plurality of geographical zones, each zone having a unique code assigned to it;
receiving the coded signal in all the geographical zones; and,
generating an alarm to warn of the approach of a danger wherein, in use, only those coded signals having the unique code assigned to a zone where there is an impending danger hazard will result in the generation of an alarm.

10. A radio activated danger warning method as defined in claim 9, wherein the coded signal is a digitally encoded signal.

11. A radio activated danger warning method as defined in claim 9 or claim 10, wherein the unique code includes global positioning coordinates defining a danger zone in which there is the impending danger hazard.

12. A radio activated danger warning method as defined in claim 11, wherein the global positioning coordinates define a geofence.

13. A radio activated danger warning method as defined in claim 12, wherein the size and location of the geofence can vary dynamically as the danger zone varies with the movement of the danger.

14. A radio activated danger warning method as defined in any one of claims 9 to 13, wherein the coded signal also includes alert codes indicating the level of danger.

15. A radio activated danger warning method as defined in claim 14, wherein the alert codes include a moderate danger alert, an urgent danger alert, and an immediate danger alert, depending on the speed and ferocity of the approaching danger front.

16. A radio activated danger warning method as defined in any one of claims 9 to 15, wherein the method preferably further includes the steps of decoding the coded signal, identifying the zone and the level of danger, before the step of generating the appropriate alarm.

17. A receiving means for a radio activated danger warning system in which a coded signal is transmitted to a plurality of geographical zones, each zone having a unique code assigned to it, the receiving means comprising:
decoding means for decoding the coded signal and alarm means for generating an alarm to warn of the approach of a danger wherein, in use, only if the receiving means belongs to a zone where there is an impending danger hazard and receives a coded signal with the unique code assigned to that zone will it generate an alarm.

18. A receiving means for a radio activated danger warning system as defined in claim 17, wherein the receiving means further comprises a radio receiver for receiving the coded signal and providing the signal to the decoding means.

19. A receiving means for a radio activated danger warning system as defined in claim 17 or claim 18, wherein the receiving means includes a GPS receiver and a comparing means whereby, in use, it can obtain its current GPS coordinates and compare them with the GPS coordinates of the danger zone.

20. A receiving means for a radio activated danger warning system as defined in any one of claims 17 to 19, wherein the alarm means generates an audible alarm.

21. A receiving means for a radio activated danger warning system as defined in claim 20, wherein the alarm means also generates a visual alarm.

22. A radio activated danger warning system comprising:
transmitting means for transmitting a coded signal to a geographical area, the coded signal including global positioning coordinates defining a danger zone in which there is an impending danger hazard within the geographical area; and,
a plurality of receiving means in the geographical area for receiving the coded signal and generating an alarm to warn of the approach of a danger wherein, in use, only those receiving means located within the danger zone and receiving the coded signal will generate an alarm.

23. A radio activated danger warning system as defined in claim 22, wherein the danger zone is defined by a geofence.

24. A radio activated danger warning system as defined in claim 23, wherein the size and position of the geofence varies dynamically as the danger zone varies with the movement of the danger.

25. A radio activated danger warning system as defined in claim 23 or claim 24, wherein the global positioning coordinates for the geofence are derived from the Global Positioning System (GPS).

26. A radio activated danger warning system as defined in any one of claims 22 to 24, wherein the global positioning coordinates are derived from any suitable Global Navigation Satellite System (GNSS).

27. A radio activated danger warning system as defined in any one of claims 23 to 26, wherein each receiving means includes a GPS receiver and a comparing means whereby, in use, it can obtain its current GPS coordinates and compare them with the geofence.

28. A radio activated danger warning method comprising the steps of:
transmitting a coded signal to a geographical area, the coded signal including global positioning coordinates defining a danger zone in which there is an impending danger hazard within the geographical area;
receiving the coded signal in the geographical area;
comparing the global positioning coordinates at the point of reception with the global positioning coordinates defining the danger zone; and,
generating an alarm to warn of the approach of a danger wherein, in use, only those coded signals received within the danger zone will result in the generation of an alarm.

29. A radio activated danger warning method as defined in claim 28, wherein the global positioning coordinates define a geofence.

30. A radio activated danger warning method as defined in claim 29, wherein the size and location of the geofence can vary dynamically as the danger zone varies with the movement of the danger.

31. A receiving means for a radio activated danger warning system in which a coded signal is transmitted to a geographical area, the coded signal including global positioning coordinates defining a danger zone in which there is an impending danger hazard within the geographical area, the receiving means comprising:
decoding means for decoding the coded signal and alarm means for generating an alarm to warn of the approach of a danger wherein, in use, only if the receiving means is located within the danger zone and receives the coded signal will it generate an alarm.

32. A receiving means for a radio activated danger warning system as defined in claim 31, wherein the receiving means further comprises a radio receiver for receiving the coded signal and providing the signal to the decoding means.

33. A receiving means for a radio activated danger warning system as defined in claim 31 or claim 32, wherein the global positioning coordinates define a geofence.

34. A receiving means for a radio activated danger warning system as defined in claim 33, wherein the size and location of the geofence can vary dynamically as the danger zone varies with the movement of the danger.

35. A receiving means for a radio activated danger warning system as defined in claim 33 or claim 34, wherein the global positioning coordinates for the geofence are derived from the Global Positioning System (GPS).

36. A receiving means for a radio activated danger warning system as defined in any one of claims 33 to claim 35, wherein the receiver further comprises a GPS receiver and a comparing means whereby, in use, it can obtain its current GPS coordinates and compare them with the geofence.

37. A receiving means for a radio activated danger warning system as defined in any one of claims 31 to claim 36, wherein the decoding means includes a GPS decoder.

38. A radio activated bush fire warning system comprising:
transmitting means for transmitting a coded signal to a plurality of geographical zones, each zone having a unique code assigned to it; and,
a plurality of receiving means in the geographical zones for receiving the coded signal and generating an alarm to warn of the approach of a fire wherein, in use, only those receiving means belonging to a zone where there is an impending fire hazard and receiving coded signals with the unique code assigned to that zone will generate an alarm.

39. A radio activated bush fire warning system as defined in claim 38, wherein the coded signal is a digitally encoded signal.

40. A radio activated bush fire warning system as defined in claim 38 or 39, wherein the unique code includes global positioning coordinates defining a danger zone in which there is an impending fire hazard.

41. A radio activated bush fire warning system as defined in claim 40, wherein the global positioning coordinates define a geofence.

42. A radio activated bush fire warning system as defined in claim 41, wherein the size and location of the geofence can vary dynamically as the danger zone varies with the movement of the fire.

43. A radio activated bush fire warning system as defined in any one of claims 38 to 42, wherein each receiving means comprises a radio receiver and a decoding means.

44. A radio activated bush fire warning system as defined in any one of claims 38 to 43, wherein each receiving means also comprises an alarm means for generating an audible alarm.

45. A radio activated bush fire warning system as defined in claim 44, wherein the alarm means also generates a visual alarm and/or a vibration alarm.

46. A radio activated danger warning system substantially as herein defined with reference to and as illustrated in any one or more of the accompanying drawings.

47. A radio activated danger warning method substantially as herein defined with reference to and as illustrated in any one or more of the accompanying drawings.

48. A receiving means for a radio activated danger warning system substantially as herein defined with reference to and as illustrated in FIG. 2 or FIG. 4 of the accompanying drawings.

49. A radio activated bush fire warning system substantially as herein defined with reference to and as illustrated in any one or more of the accompanying drawings.
